(19) United States
(12) Patent Application Publication
(10) Pub. No.: US 2025/0293544 A1
(43) Pub. Date: Sep. 18, 2025

(54) NEUTRAL ENERGY HARVESTING SYSTEMS AND METHODS

(71) Applicant: Sentient Energy Technology, LLC, Wichita, KS (US)

(72) Inventors: Robert Nicholas PATRICK, Wichita, KS (US); Bidesh KAR, Wichita, KS (US)

(21) Appl. No.: 18/860,398

(22) PCT Filed: Apr. 14, 2023
(86) PCT No.: PCT/IB2023/053838

§ 371 Date: Oct. 25, 2024

Related U.S. Application Data
(60) Provisional application No. 63/334,583, filed on Apr. 25, 2022.

(51) Int. Cl. H02J 50/00; H01F 27/24; H01F 27/28; H02J 50/10

(52) U.S. Cl. CPC H02J 50/001; H01F 27/24; H01F 27/28; H02J 50/10

(57) ABSTRACT

A neutral energy harvesting system is provided that harvests energy from an alternating current (AC) distribution neutral line by using a solid magnetic core as a transformer. The primary winding is electrically coupled to the neutral line, which may be disconnected to direct all of the neutral current through the primary winding. The secondary winding output may be converted to a direct current (DC) voltage, and the energy is stored and/or used to supply power for one or more sensors.

### CROSS-REFERENCE TO RELATED APPLICATIONS

This application claims priority to, and the benefit of, U.S. Provisional Patent Application No. 63/334,583, entitled “NEUTRAL ENERGY HARVESTING SYSTEMS AND METHODS,” filed on Apr. 25, 2022, which is incorporated herein by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

This disclosure generally relates to Power Line Energy Harvesting. More specifically, the Harvesting of energy from a neutral line of a power system.

### BACKGROUND

Numerous examples of prototype and commercially available line sensors derive power from a primary cell storage battery that both limits and defines operational and communications availability. A limited number of line sensors may include rechargeable cells harvesting solar energy and/or the electromagnetic field of the hot conductor to extend operational and communications availability (GridSentry and others). Harvesting energy from the electromagnetic field in the proximity of the hot conductor can be engineered with magnetic cores around the hot conductor, capturing the magnetic field created by line current flow and transforming it to an alternating current (AC) voltage. Split-core toroidal transformers can be mounted around a hot conductor, eliminating the need to cut and splice the conductors. Split cores may be used for ease of installation with the tradeoff of having a core that is split sacrificing some of its magnetic performance, as well as wear due to ambient conditions and its effects such as rusting. Additionally, power line vibration causes friction of the cut core faces which wears them down mechanically as well as creating debris between the core faces which diminishes performance. Power harvesting using induction pick-up from the magnetic field surrounding a power distribution line can be used to provide power to distribution line monitoring sensors. Typically, the power line is routed through a current transformer whereby an AC signal is derived from the magnetic field induced by the AC current flow in the distribution line. The AC signal is converted to direct current (DC) as part of the power harvesting process and used to power the monitoring sensors and associated electronics. This is typically referred to as “inductive harvesting using current transformers.”

One method of mounting the current transformer (CT) on the distribution line is to cut the CT in two, mount the halves around the uncut distribution line, and mechanically hold the two CT halves together. Because the changing magnetic field (AC) causes the magnetic force of attraction between halves of a split core current transformer to alternate between a zero force and a peak force at twice the AC line frequency, the core halves need to be mechanically held together, which can be challenging in a hot stick deployed sensor application. Such current transformers, when combined with power conversion circuitry, can provide power to the internal circuitry of the sensor. One limitation of this approach is that the current transformer derived from a split core has lower performance than that of a solid core and can rust at the interface between the two halves.

Power line sensors used in electric power distribution applications are subjected to the full extent of possible environmental conditions over many years of unattended operation. The devices are required to be small and reasonably lightweight, while mechanically and electrically robust. Protecting the electronic components from environmental stresses is critical for long product life, but conventional methods of constructing outdoor enclosures do not satisfy the full range of requirements. Difficult to survive environmental conditions include driving rain which can result in liquid water in proximity to gapped interfaces which then wick the moisture into sensitive areas. Difficult to survive marine environments where salts are deposited and concentrated over time on housings result in an exceptionally corrosive environment for most metals. Difficult to survive freezing conditions where liquid water can freeze and apply mechanical loads on mechanisms. The complexity of installation on energized lines dictates the need for mechanical details which minimize the number of installers and tools required to complete a sensor placement. The need to remove failed devices in various states of operation can require features that are necessary only in those cases. Application specific designs and construction details can be required to satisfy these and other situations. As mentioned, a solid core increases the cores longevity due to lack of magnetic interfaces within the core. It does though present the problem of installation. To place the solid core around a distribution line typically necessitates the deenergizing of the line, and breaking the physical connection of the distribution line in order to slide the core over the conductor. This sometimes requires the removal and reinstallation of the cable coupling elbow. Such deenergizing and breaking physical connection is undesirable in many applications.

### SUMMARY OF THE DISCLOSURE

Embodiments herein harvest energy from the shared concentric neutral of an MV power distribution line. Embodiments utilize a solid core with a winding that is electrically coupled in series with a power line neutral to ground. To install the energy harvesting device, the device may be coupled to the neutral and the ground then the neutral is disconnected from ground so that that any current is forced through the winding wrapped around the solid core. For example, to disconnect the neutral, often the wires are connected to the ground bar via a split bolt. In such embodiments, the harvest core may be connected, and then the split bolt is disconnected, and the neutral is folded back, leaving the cable intact in the event that the harvest core was to be removed and the neutral reconnected directly to the bus bar. In this manner, electric service is not interrupted during installation. The winding consists of a high-fidelity conductor and replaces the existing exposed copper neutral and allows for the multiplication of the harvested current via pre-wound turns through the harvesting core. The device can benefit from having a solid core in that it can be made fully sealed and waterproof. Additionally, a solid core can attain higher flux densities than a split core equivalent core. The solid core approach outlined also allows for multiple windings in contrast to a split core that usually has a single winding for its primary winding. The solid core for these applications allows its use in a neutral energy harvest due to the ability to develop higher N*I and a resultant higher flux.

In embodiments the core is wrapped with wire and connected from the concentric shield of a power distribution line and attached to ground. The copper strap that ties the concentric shield to ground is then disconnected forcing the ground current from the concentric shield though the winding of the solid core in the manner discussed. The harvesting coil may be installed safely in a system without deenergizing it. It may also be safely uninstalled without de-energizing the system.

The wire for the primary winding of the transformer is sized to handle the highest current due to the current carried on the concentric neutral of the power cable during a high current fault (i.e., fault current). The harvest core can handle the same current as the cable center conductor which has 3× more ampacity than the neutral. A second winding around the core would act as a secondary and the current and energy of the output from the secondary would be stored and used to power a sensor. The concentric shield of the power line carries current from the imbalance of the three phases. This is true if the power connection is that of a delta connection. In an ideal power system, the three phase signals cancel to produce a constant power flow. That is when they are perfectly balanced. In the event of an imbalance current flows through their canonical shields connected to ground. The presence of certain harmonics can also cause a current flow in the canonical shield.

### BRIEF DESCRIPTION OF THE DRAWINGS

The novel features of at least some embodiments of the invention are set forth and particularity in the claims that follow. A better understanding of the features and advantages of the present invention will be obtained by reference to the following detailed description that sets forth illustrative embodiments, in which the principles of the invention are utilized, and the accompanying drawings.

FIG. 1A shows a connection in a panel of three power distribution lines using a neutral energy harvesting system and method, in one or more embodiments.

FIG. 1B shows a cut-away perspective view of an example power distribution line of FIG. 1A, in further detail.

FIG. 1C shows a connection in a panel of three power distribution lines using a neutral energy harvesting system and method after the harvester is installed.

FIG. 2 shows the energy harvesting transformer with its power electronics. electronics.

FIG. 3 illustrates in more detail the neutral harvest system with its associated power electronics and the sensors

FIG. 4 shows the energy harvesting transformer with a saturating clamping winding.

FIG. 5 shows the energy harvesting transformer with power electronics for the secondary and the clamp circuit.

FIG. 6 shows a method for connecting the energy harvesting core to a concentric neutral.

### DETAILED DESCRIPTION

At least some embodiments herein harvest energy from the shared concentric neutral of a medium voltage (MV) power distribution line. For example, MV may range from 1 kilovolt (kV) up to 52 kV. The advantage of a solid core transformer for energy harvesting is that it has no split interface of the core that is exposed to the weather making mechanical complexity simpler. A solid core transformer can develop higher levels of flux for energy transfer and allows multiple loops of wire about the core, increasing the number of windings and creating a higher magneto motive force. This allows the applications where lower amounts of current are available. Energy harvesters with sensor suites may be installed in more places. They may be installed in smaller grids and lower power transmission systems, such as on the neutral or the canonical shield of the distribution line of a power system. The primary winding of the harvester winding allows it to be installed in a system where the power remains energized. The system does not have to be powered down.

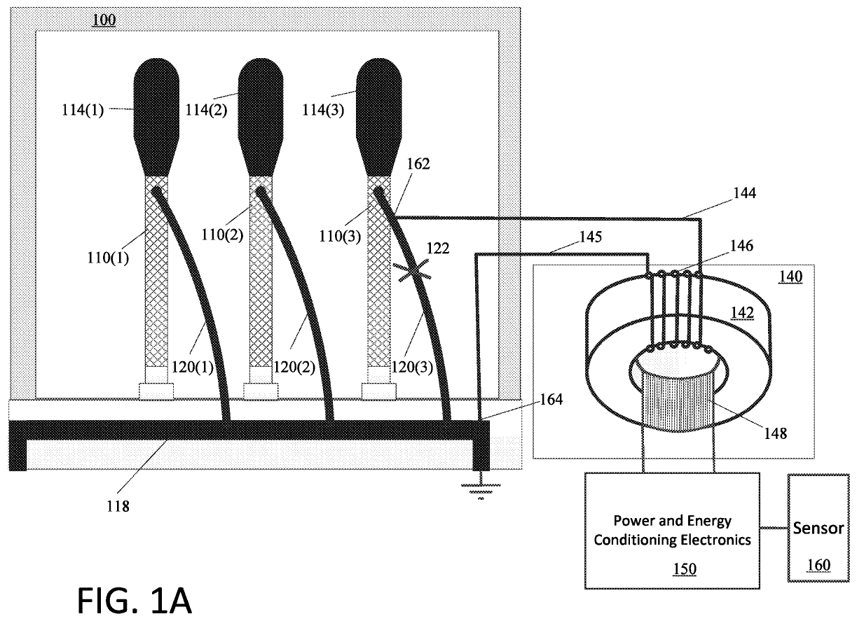

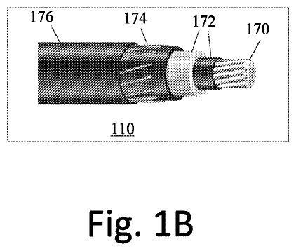

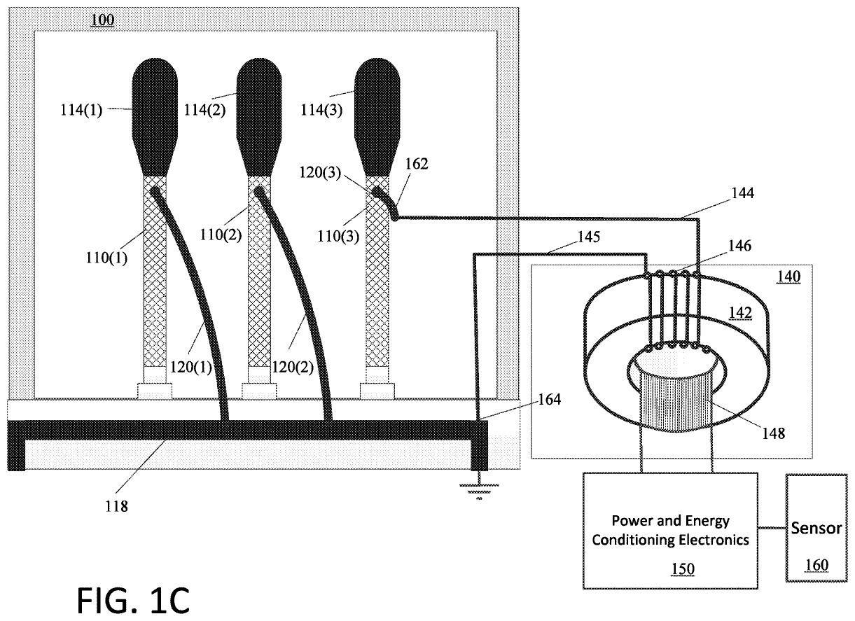

FIG. 1A shows a connection in a panel 100 of three power distribution lines 110(1), 110(2), and 110(3) using a neutral energy harvesting system and method, in one or more embodiments. FIG. 1B shows a cut-away perspective view of an example power distribution line 110, of FIG. 1A in further detail. FIGS. 1A-B are best viewed together with the following description.

Power distribution lines 110 are terminated in the panel 100 with insulative boots 114(1) 114(2), and 114(3). Each power distribution line 110 carries a neutral, which may be a concentric conducting shield 174, that is connected to a respective ground strap 120(1), 120(2), or 120(3). Each power distribution line 110 is made up of a center conductor 170 with two layers of insulation 172 and a concentric conducting shield 174. It may also have an outer insulator 176. The power system shown in panel 100 is one that is connected to a transformer that is in a Delta configuration. In a Delta configuration, the current in the concentric conducting shield 174 should be zero in a perfectly balanced system. However, any imbalance may end up in a resulting current through the concentric conducting shield 174. This current will be conducted through the ground strap 120(1), 120(2), and 120(3) electrically coupled to its grounded busbar 118.

In embodiments herein, the imbalance ground current may be harvested and used to store energy through a neutral energy harvester 140. This is done by disconnecting one or more of the ground straps 120 (e.g., at disconnect location 122 in FIG. 1A), and connecting through the primary winding of a solid core 142 transformer of the neutral energy harvester 140. A first primary electrode 144 (e.g., a first end of the wire forming the primary winding 146 of the solid core transformer) connects to the concentric conducting shield 174 or a ground strap 120(3) coupled to the concentric conducting shield 174 at node 162 and connects the second primary electrode 145 (e.g., a second end of the wire forming the primary winding 146 of the solid core transformer) to the grounded busbar 118 (or a portion of the ground strap 120(3) coupled thereto) at second node 164 which completes the path to ground. The primary winding 146 between the first primary electrode 144 and second primary electrode 145 wraps the solid core 142 with a number of turns. In the embodiment shown in FIG. 1A, there are 6 turns, although there may be more or fewer turns without departing from the scope hereof. The wire used for the primary winding 146 (and primary electrodes 144, 145 thereof) will be of a gauge necessary to conduct full current in the event of a fault. Thus, the primary winding has a diameter that allows for full fault current without damage to the primary winding the solid core. The current through the primary winding is normally low and may be as low as several hundred milliamperes. A split core transformer would not be able to develop enough flux to effectively transfer the energy out of the secondary winding 148. The solid core 142, however, can essentially double the flux that would be developed over a split core overcoming the losses in the gap that is generated in the split and allowing multiple turns made possible by use of the solid core.

The solid core 142 is wrapped by a secondary winding 148 with an integer multiple number of turns to that of the primary winding 146. For example, the secondary winding 148 may contain 5 to 10 times the number of turns of the primary winding 146 or thirty to sixty turns. There could be more or fewer turns than shown without departing from the scope hereof. The secondary winding 148 is electrically coupled to power and energy conditioning electronics 150 that converts the alternating current from the secondary winding 148 to a direct current to be stored in an energy storage device and also can power a sensor 160 or other electronic device(s) (such as a suite of sensors, and associated controller therefore). One example of the sensor 160 is the SENTIENT ENERGY UM3+ sensor.

In some embodiments, the neutral energy harvester 140 may have an element such as a hole so that the element can be used for mounting or attaching the neutral energy harvester 140 to a ground bar or other nearby structure in order to relieve stress on the concentric conducting shield 174 to which the neutral energy harvester 140 is attached.

FIG. 1C shows a connection in a panel of three power distribution lines using a neutral energy harvesting system and method after the harvester is installed. The primary winding of the neutral energy harvester 140 is electrically coupled at one end (end of first primary electrode 144) to the ground strap 120(3). The ground strap 120(3) has been disconnected after the neutral energy harvester 140 was electrically coupled at first node 162 and second node 164. The second electrode of the primary winding 146 is electrically coupled to the ground busbar 118. Installation in the manner represented by FIGS. 1A, 1C provides the benefit of installing the neutral energy harvester 140 without interruption to the power network.

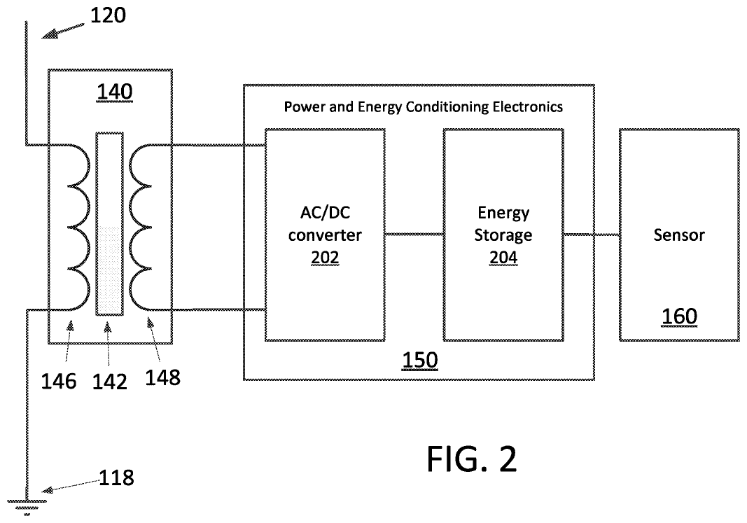

FIG. 2 shows the neutral energy harvester 140 with its power electronics. The transformer has the solid core 142 and a primary winding 146 that is in series with the neutral of the power distribution line 110 (e.g., the concentric conducting shield 174 and/or ground strap 120) and ground (e.g., the ground busbar 118). The secondary winding 148 is connected to power and energy conditioning electronics 150 that includes an AC/DC converter 202 and Energy Storage 204. The power and energy conditioning electronics 150 convert the AC output of the secondary winding 148 to DC. This may be done by a full bridge rectifier using diodes or Field Effect Transistors (FET) switches that synchronously rectify the output. A half bridge rectifier, a voltage doubler, or a voltage multiplier may also be implemented, in embodiments. The output of the rectifier may be filtered and fed into a storage device 204. Examples of storage device 204 include, but are not limited to, any one or more of a capacitor, a lithium hybrid supercapacitor, or other super capacitor, a rechargeable battery, and combinations thereof. A preferred embodiment is to use a super capacitor for the energy storage device. The output of the power and energy conditioning electronics 150 powers a sensor 160.

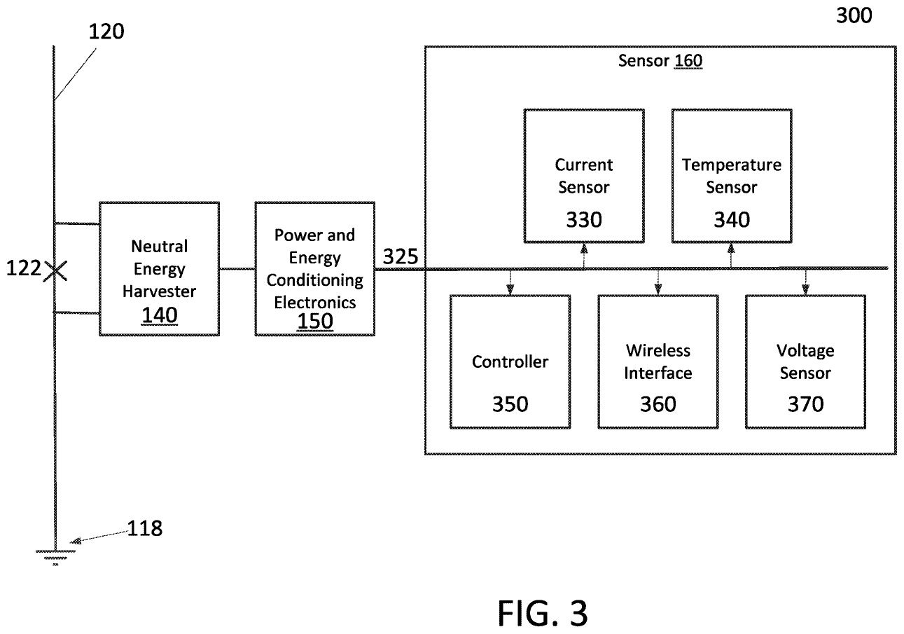

FIG. 3 illustrates in more detail the neutral harvest system 300 with its associated power electronics and the sensors it may drive, in embodiments. The system 300 contains a neutral energy harvester 140, power and energy conditioning electronics 150, and a sensor 160. Power and energy conditioning electronics 150 include an AC/DC converter 202 and energy storage 204. The output of the power and energy conditioning electronics 150 powers a sensor 160. Sensor 160 may include one or more of a controller 350, a voltage sensor 370, a current sensor 330, temperature sensor 340, a wireless communication circuit 360 used to telemeter information to a base station, and any combination thereof. It can also be used to power a variety of digital inputs or outputs. The primary winding of the neutral energy harvester 140 is electrically coupled in series between the neutral of the power distribution line 110 (e.g., the concentric conducting shield 174 and/or ground strap 120) and ground (e.g., the ground busbar 118). The ground strap 120 can be disconnected (e.g., at the disconnect location 122) so that the neutral current is forced through the primary winding 146 of the neutral energy harvester 140.

The output of the neutral energy harvester 140, its secondary winding 148, supplies power to an AC/DC converter (e.g., converter 202) and whose energy is stored in an energy storage device (e.g., energy storage device 204). The AC/DC Converter may be a half wave or a full wave bridge rectifier. A voltage doubler, or a voltage multiplier may also be implemented, in embodiments. It may also use (FETs) to synchronously rectify the AC and convert it into a pulsating DC. Filters may be used to minimize the ripple. The output of the power and energy conditioning electronics 150 is coupled to a DC bus 325. The DC bus 325 drives the sensors 160 and excess energy is stored in the energy storage 204 (or at an external energy storage unit that is a component of the sensor 160). The power bus delivers power to one or more of the controller 350, a wireless communication circuit 360, a voltage sensor 370, current sensor 330, and/or a temperature sensor 340. The controller 350 may manage an interface to track how much energy is stored in the energy storage and controls the other sensors and systems. The controller 350 may also be used to control the DC bus 325 so that it can draw more or less power from the energy harvester, draw or sink energy from/to the energy storage, or enable or shed the loads that are in sensor 160. For example, controller 350 may only enable each element of sensor 160 for a short period of time rationing the energy that is otherwise being stored.

The neutral energy harvester 140 delivers energy over a long period of time and the energy storage 204 levels the load so that peak power excursions come from the storage and is refilled from the energy harvester. The controller 350 may turn on the wireless communication circuit 360 to send the data accumulated over a period of time. The controller 350 enables the current sensor 330 to measure current from a line and then may shut the current sensor 330 off. The controller 350 turns on the voltage sensor 370 to take a reading then may shut the voltage sensor 370 off. Also, the controller 350 can measure ambient temperature using the temperature sensor 340 and may then shut off the temperature sensor 340 in order to use as little energy as necessary.

All of the electronics may be selected as they are required to process the current and voltage that appears from the secondary winding. Clamp circuits may be used to limit how much voltage may be presented by the secondary winding in the event of a fault. Additionally, a saturating clamping winding (or clamp winding) may be used to also limit the voltage. The harvester coil is a transformer and, as such by limiting the voltage at one winding, the voltage is limited for all its windings.

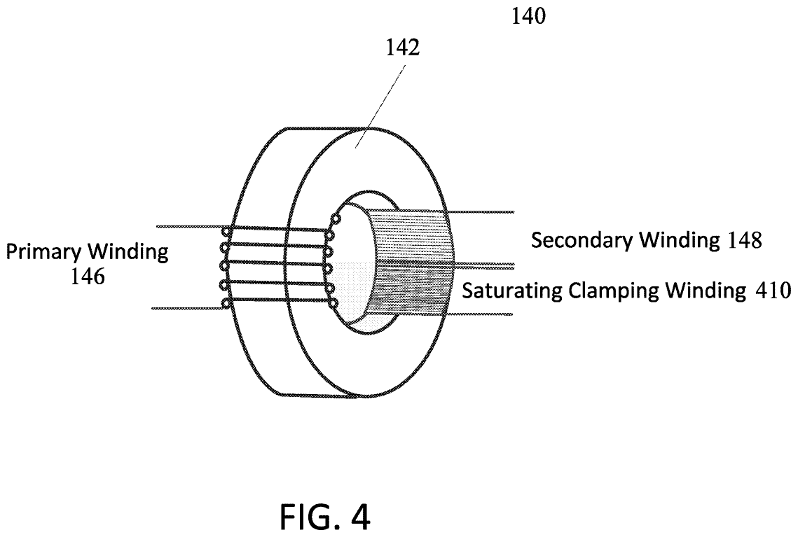

FIG. 4 shows the neutral energy harvester 140 with a saturating clamping winding 410. The neutral energy harvester 140 includes a transformer having a primary winding 146, which is the same winding in the previous examples, as well as the same secondary winding 148, both wrapped around the same core 142. The neutral energy harvester 140 also has a third winding 410 that is used as a saturating clamping winding 410. The saturating clamping winding 410 may have more turns than that of the secondary winding 148. Limiting the voltage of the saturating clamping winding 410 may also limit the voltage of the secondary winding 148. Although saturating clamps and voltage limiters may be placed on the secondary winding 148 directly, the use of a clamping winding 410 is convenient, and with a greater number of turns than the secondary winding 148, the voltage will be higher and therefore the sensitivity for the clamping circuits may be higher.

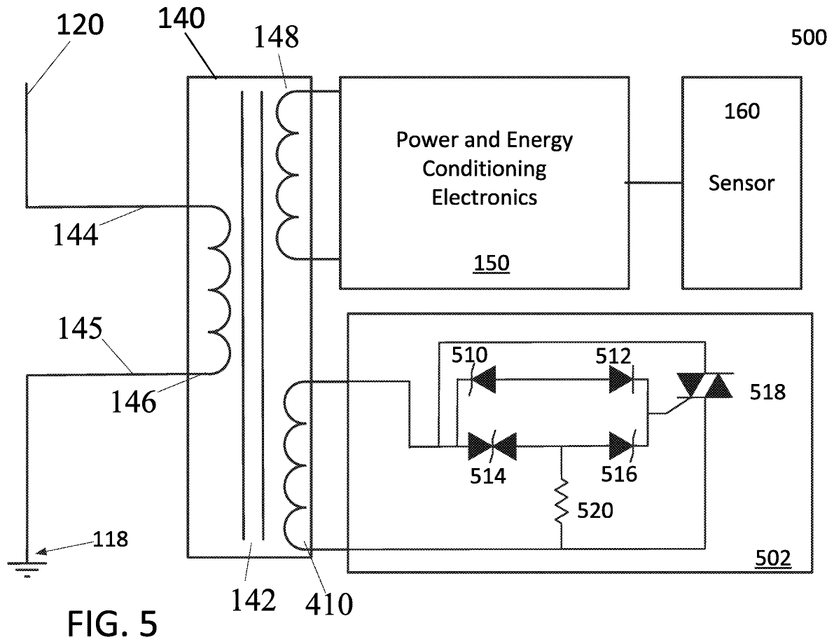

FIG. 5 shows the neutral energy harvester 140 with a saturating clamping winding 410 according to one or more embodiments. FIG. 5 illustrates an energy harvesting system 500 using a secondary winding 148 for powering sensors and a saturating clamping winding 410 and control circuit 502 used to limit the voltage of the clamp winding 410 and therefore all windings. The neutral energy harvester 140 may have an energy harvesting core 142 with a primary winding 146 electrically coupled to a concentric shield ground strap 120 at one terminal end and may be electrically coupled to ground busbar 118 on the other terminal end. The secondary winding 148 may be electrically coupled to power and energy conditioning electronics 150 containing an AC/DC converter with energy storage which power the sensor 160. The clamp winding 410 may be connected to a control circuit 502.

In the embodiment of FIG. 5, the control circuit 502 includes a Zener diode 510, a diode 512, a Transient Voltage Suppressor (TVS) diode 514, a Zener diode 516, a triode for alternating current (TRIAC) 518, and a resistor 520. Other control circuits may be implemented without departing from the scope hereof. The control circuit 502 is electrically coupled to the clamp winding 410. The control circuit 502 has three modes of operating. At low current and voltages, control circuit 502 does nothing. With a sufficiently low voltage Zener diodes remain in their reverse bias or conduction states but do not break down. At a medium voltage range the positive voltage swing on the clamp winding will reverse bias the Zener diode 510 which in turn forward biases diode 512 and drives the gate of the TRIAC 518 turning it on and shorting out the winding with a DC short. The negative swing however acts as it did before. When the negative swing exceeds a threshold breaking down the TVS diode 514 and 516 to a voltage that is sustained buy the resistor 520 and once again triggers the TRIAC 518 to its conduction state placing a DC short across the clamp winding 410. The various thresholds are determined to a first order by the diodes 510, 514, and 516.

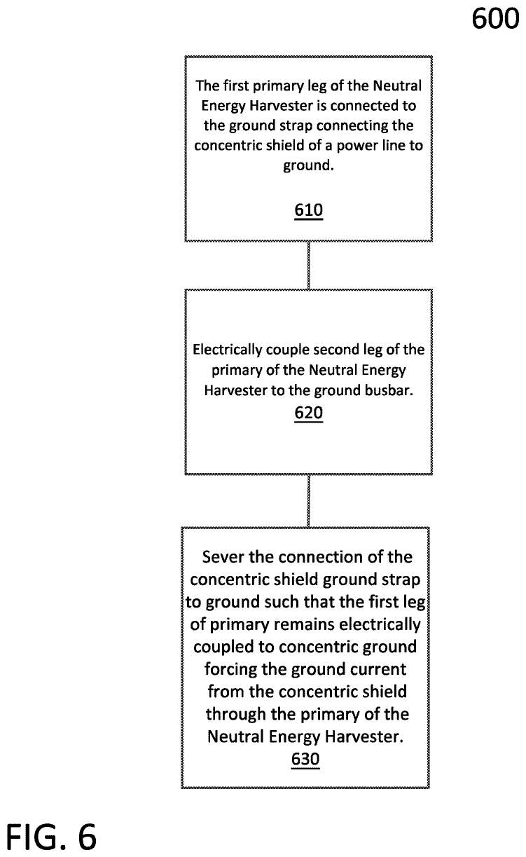

FIG. 6 shows a method 600 for connecting the energy harvesting core to a concentric neutral. Method 600 shows connecting a neutral energy harvester to the concentric ground of a power line without deenergizing the power line. Method 600 may be implemented using any of the above-described neutral energy harvesters (e.g., neutral energy harvester 140).

In block 610, a first primary electrode of the primary winding of the neutral energy harvester is connected to the ground strap 120 connecting the concentric shield of a power line to ground, thereby electrically coupling the first primary electrode of the primary winding of the neutral energy harvester to the concentric shield ground strap. In one example of block 610, referring to FIGS. 1A-C, the first primary electrode 144 is coupled to the ground strap 120(3) at node 162.

In block 620, a second primary electrode of a primary winding of the neutral energy harvester is coupled to the ground. In one example of block 610, referring to FIGS. 1A-C, the second primary electrode 145 is coupled to the ground busbar 118 at node 164.

In block 630, the ground strap 120 may be disconnected between the first and second nodes. In one example of operation, ground strap 120(3) is disconnected between first node 162 and second node 164 so as to place the neutral energy harvester 140 in series with the power distribution line 110 and ground busbar 118. Thus, block 630 disconnects the connection of the concentric shield ground strap 120 to ground such that the first electrode of primary winding remains electrically coupled to concentric ground forcing the ground current from the concentric shield through the primary winding of the neutral energy harvester.

For the neutral, the wires are often connected to the ground bar via a split bolt. In such embodiments, the harvest core may be connected and then the split bolt is disconnected, and the neutral is folded back leaving the cable intact in the event that the harvest core was to be removed and the neutral reconnected directly to the bus bar.

Once installed via method 600, the neutral energy harvester may be used to store energy in an energy storage device and/or power one or more sensors coupled thereto as discussed above.

Embodiments of the present disclosure may be described in one or more of the following clauses:

Clause 1. A neutral energy harvesting system, comprising: a transformer having: a solid magnetic core; a primary winding wrapped around the solid magnetic core, the primary winding having a first primary electrode and a second primary electrode, the first primary electrode configured to couple to a first node of a neutral line of an alternating current (AC) power distribution system, and the second primary electrode configured to couple to a second node of the neutral line; and a secondary winding wrapped around the solid magnetic core.

Clause 2. The neutral energy harvesting system of clause 1, wherein the neutral line is open at a point between the first node and the second node such that the transformer is in series between the first node and the second node.

Clause 3. The neutral energy harvesting system of clauses 1 to 2, wherein the primary winding has a diameter that allows for full fault current without damage to the primary winding of the solid magnetic core.

Clause 4. The neutral energy harvesting system of clauses 1 to 3, wherein a number of windings of the primary winding is less than a number of windings of the secondary winding.

Clause 5. The neutral energy harvesting system of clauses 1 to 4, wherein the secondary winding is electrically coupled to an AC to direct current (DC) converter.

Clause 6. The neutral energy harvesting system of clause 5, wherein the AC to DC converter is electrically coupled to an energy storage device.

Clause 7. The neutral energy harvesting system of clause 6, wherein the energy storage device is one or more of: a capacitor, a supercapacitor, a battery, or a fuel cell.

Clause 8. The neutral energy harvesting system of clauses 6 to 7, wherein the energy storage device is electrically coupled to a sensor.

Clause 9. The neutral energy harvesting system of clause 8, wherein the sensor includes at least one of: a voltage sensor, a current sensor, or a temperature sensor.

Clause 10. The neutral energy harvesting system of clauses 1 to 9, the transformer further comprising a clamp winding.

Clause 11. The neutral energy harvesting system of clause 10, the clamp winding being electrically coupled to a clamp drive.

Clause 12. The neutral energy harvesting system of clauses 1 to 11, wherein the secondary winding is electrically coupled to an AC to DC converter with energy storage, and the AC to DC converter with energy storage is electrically coupled to a power bus.

Clause 13. The neutral energy harvesting system of clause 12, wherein the power bus is electrically connected to a controller.

Clause 14. The neutral energy harvesting system of clauses 12 to 13, wherein the power bus is electrically coupled to one or more of: a current sensor, voltage sensor, a temperature sensor, or a wireless interface.

Clause 15. A method of harvesting energy, comprising: electrically coupling a first primary electrode of a neutral energy harvester to a first node coupled to a neutral of a power line; electrically coupling a second primary electrode of the neutral energy harvester to a second node coupled to a ground; and disconnecting an electrical connection between the first node and the second node.

Clause 16. The method of clause 15, wherein the neutral is a concentric shield of the power line.

Clause 17. The method of clauses 15 to 16, wherein the ground is a ground busbar.

Clause 18. The method of clauses 15 to 17, further comprising storing energy in an energy storage device using the neutral energy harvester.

Clause 19. The method of clauses 15 to 18, further comprising powering a sensor using energy captured by the neutral energy harvester.

Clause 20. The method of clauses 15 to 19, further comprising limiting voltage at a secondary winding of the neutral energy harvester with a clamp winding.

The neutral energy harvester described herein may incorporate additional features without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A neutral energy harvesting system, comprising:
a transformer having:
a solid magnetic core;
a primary winding wrapped around the solid magnetic core, the primary winding having a first primary electrode and a second primary electrode, the first primary electrode configured to couple to a first node of a neutral line of an alternating current (AC) power distribution system, and the second primary electrode configured to couple to a second node of the neutral line; and
a secondary winding wrapped around the solid magnetic core.

2. The neutral energy harvesting system of claim 1, wherein the neutral line is open at a point between the first node and the second node such that the transformer is in series between the first node and the second node.

3. The neutral energy harvesting system of claim 1, wherein the primary winding has a diameter that allows for full fault current without damage to the primary winding of the solid magnetic core.

4. The neutral energy harvesting system of claim 1, wherein a number of windings of the primary winding is less than a number of windings of the secondary winding.

5. The neutral energy harvesting system of claim 1, wherein the secondary winding is electrically coupled to an AC to direct current (DC) converter.

6. The neutral energy harvesting system of claim 5, wherein the AC to DC converter is electrically coupled to an energy storage device.

7. The neutral energy harvesting system of claim 6, wherein the energy storage device is one or more of: a capacitor, a supercapacitor, a battery, or a fuel cell.

8. The neutral energy harvesting system of claim 6, wherein the energy storage device is electrically coupled to a sensor.

9. The neutral energy harvesting system of claim 8, wherein the sensor includes at least one of: a voltage sensor, a current sensor, or a temperature sensor.

10. The neutral energy harvesting system of claim 1, the transformer further comprising a clamp winding.

11. The neutral energy harvesting system of claim 10, the clamp winding being electrically coupled to a clamp drive.

12. The neutral energy harvesting system of claim 1, wherein the secondary winding is electrically coupled to an AC to DC converter with energy storage, and the AC to DC converter with energy storage is electrically coupled to a power bus.

13. The neutral energy harvesting system of claim 12, wherein the power bus is electrically connected to a controller.

14. The neutral energy harvesting system of claim 12, wherein the power bus is electrically coupled to one or more of: a current sensor, voltage sensor, a temperature sensor, or a wireless interface.

15. A method of harvesting energy, comprising:
electrically coupling a first primary electrode of a neutral energy harvester to a first node coupled to a neutral of a power line;
electrically coupling a second primary electrode of the neutral energy harvester to a second node coupled to a ground; and
disconnecting an electrical connection between the first node and the second node.

16. The method of claim 15, wherein the neutral is a concentric shield of the power line.

17. The method of claim 15, wherein the ground is a ground busbar.

18. The method of claim 15, further comprising storing energy in an energy storage device using the neutral energy harvester.

19. The method of claim 15, further comprising powering a sensor using energy captured by the neutral energy harvester.

20. The method of claim 15, further comprising limiting voltage at a secondary winding of the neutral energy harvester with a clamp winding.
